(19) United States
(12) Patent Application Publication
(10) Pub. No.: US 2020/0077060 A1
(43) Pub. Date: Mar. 5, 2020

(54) Image Calibration Method and Projector System Capable of Adjusting a Distorted Image Automatically

(71) Applicants: BenQ Intelligent Technology (Shanghai) Co., Ltd, Shanghai (CN); BENQ CORPORATION, Taipei (TW)

(72) Inventor: Chang-Jung Tai, Taipei (TW)

(21) Appl. No.: 16/546,318

(22) Filed: Aug. 21, 2019

(30) Foreign Application Priority Data
Aug. 29, 2018 (CN) 201810996659.5

(51) Int. Cl. H04N 9/31; G06T 5/00; G06T 7/73; G03B 21/56

(52) U.S. Cl. CPC H04N 9/3185; G03B 21/56; G06T 7/73; G06T 5/006

(57) ABSTRACT

An image calibration method includes setting a plurality of positioning devices on a projection plane, acquiring a plurality of coordinates of the plurality of positioning devices on the projection plane, and controlling a first projector for adjusting a first raw image projected by the first projector to a first adjusted image cornered at the plurality of coordinates. The first adjusted image is a polygonal image without introducing a keystone distortion.

### BACKGROUND OF THE INVENTION

### 1. Field of the Invention

The present invention illustrates an image calibration method and a projector system, and more particularly, an image calibration method and a projector system capable of adjusting a distorted image automatically according to coordinates of a plurality of positioning devices.

### 2. Description of the Prior Art

With the rapid advancement of technologies, various advanced display technologies are developed and adopted in our daily life. For example, high-resolution displays and portable projection devices are also widely used. Projection technologies can be integrated into display applications for increasing capabilities of conventional displays, such as providing a space art effect, providing an augmented reality (AR) effect, and reducing blind spots. Nowadays, many three-dimensional projection technologies can be combined with various optical technologies for generating several amazing visual effects to provide a surreal visual experience for users. In particular, since a space utilization is an important issue, ultra short throw (UST) projectors become popular when large-size images are projected to a projection plane with a short focal length. The UST projectors can be used in various spaces, especially in small conference rooms. The UST projector has a very short focal length for projecting images. Since the UST projector has the very short focal length, a light distance between the UST projector and the projection plane can be greatly reduced, thereby protecting the user's eyes. However, one problem of the UST projector is that the projected image is prone to generating image distortion. In other words, the shorter light distance between the UST projector and the projection plane is used, the more obvious image distortion caused by optical bias may be introduced. For example, the projected image generates a keystone distortion when the projector is rotated or shifted along a horizontal axis and/or a vertical axis.

At present, the keystone distortion of the projected image can be calibrated by manually adjusting offset along the horizontal and vertical axes of the projector, or calibrated by using a built-in automatic keystone calibration function. For example, the user can calibrate the distortion of the projected image by using a keystone calibration function key displayed on an on-screen display (OSD) interface. However, using the automatic keystone calibration function or using the manual calibration process for calibrating the distortion of the projected image lacks calibration accuracy and may take a lot of time, especially in the UST projectors.

### SUMMARY OF THE INVENTION

In an embodiment of the present invention, an image calibration method is disclosed. The image calibration method comprises setting a plurality of positioning devices on a projection plane, acquiring a plurality of coordinates of the plurality of positioning devices on the projection plane, and controlling a first projector for adjusting a first raw image projected by the first projector to a first adjusted image cornered at the plurality of coordinates. The first adjusted image is a polygonal image.

In another embodiment of the present invention, a projector system is disclosed. The projector system comprises a first projector, a projection plane, a plurality of positioning devices, and a processor. The first projector is configured to project an image. The projection plane is configured to display the image projected by the first projector. The plurality of positioning devices are disposed on the projection plane and configured to determine a display range of the image. The processor is coupled to the first projector and the plurality of positioning devices and configured to control the first projector according to a plurality of coordinates of the plurality of positioning devices. After the processor acquires the plurality of coordinates of the plurality of positioning devices on the projection plane, the processor controls the first projector for adjusting a first raw image projected by the first projector to a first adjusted image cornered at the plurality of coordinates. The first adjusted image is a polygonal image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structure of a projector system according to an embodiment of the present invention.

FIG. 2 is an illustration of adjusting a first raw image projected by a first projector to a first adjusted image of the projector system in FIG. 1.

FIG. 3 is an illustration of scanning a projection plane along a vertical axis by using horizontal scanning light of the projector system in FIG. 1.

FIG. 4 is an illustration of scanning the projection plane along a horizontal axis by using vertical scanning light of the projector system in FIG. 1.

FIG. 5 is an illustration of moving a plurality of positioning devices for generating a second adjusted image of the projector system in FIG. 1.

FIG. 6 is an illustration of introducing a second adjusted image projected by a second projector for combining with the first adjusted image to form a stitching image of the projector system in FIG. 1.

FIG. 7 is an illustration of introducing a second adjusted image projected by a second projector for overlaying with the first adjusted image to form an overlapped image of the projector system in FIG. 1.

FIG. 8 is a flow chart of an image calibration method performed by the projector system in FIG. 1.

### DETAILED DESCRIPTION

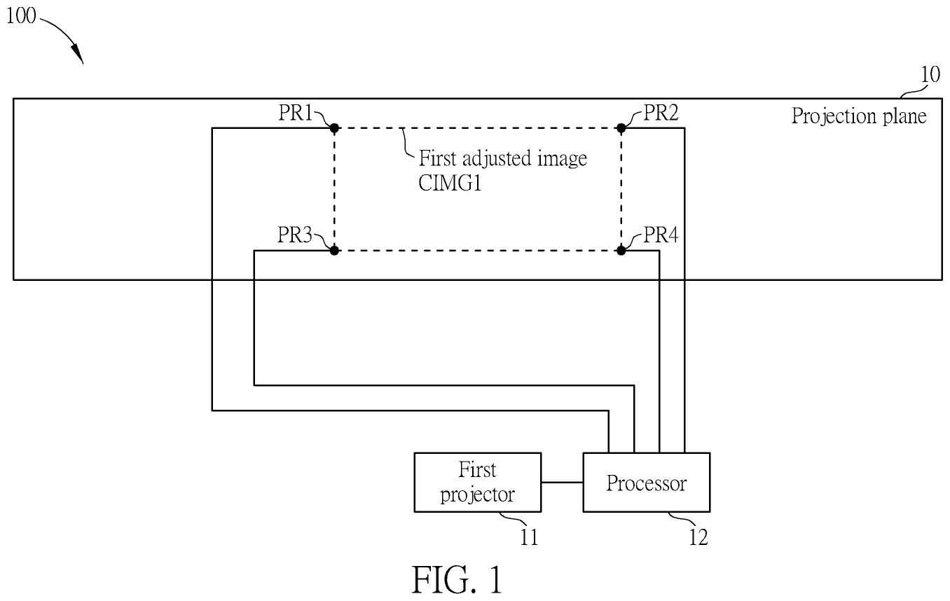

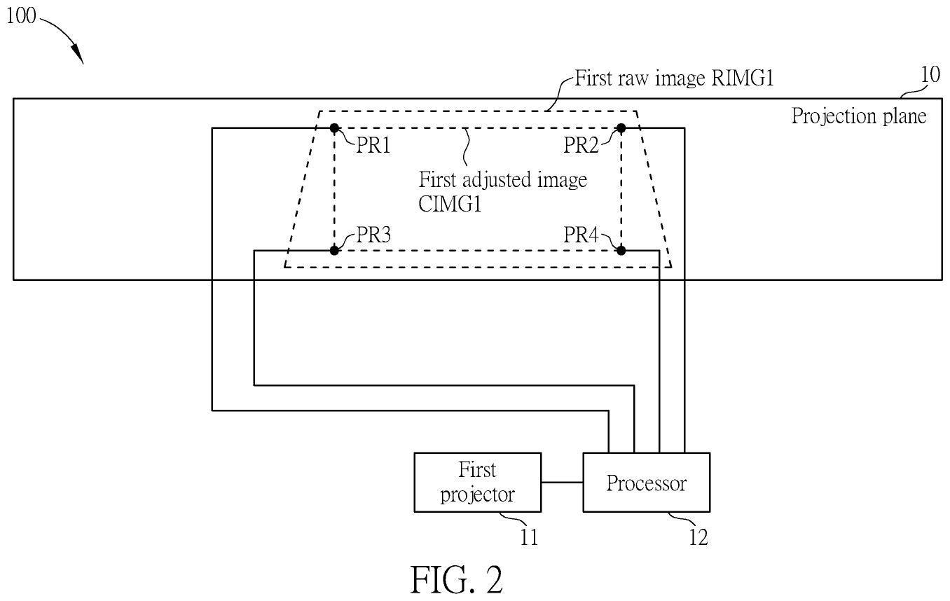

FIG. 1 is a structure of a projector system 100 according to an embodiment of the present invention. The projector system 100 can include a projection plane 10, a first projector 11, a plurality of positioning devices PR1 to PR4, and a processor 12. The projection plane 10 is used for displaying an image projected by the first projector 11. The projection plane 10 can be a screen, a wall, a curtain, or any projection surface with any shape. The projection plane 10 can display a light beam emitted from the first projector 11. The first projector 11 can be any type of projectors, such as a laser projector, a digital light processing (DLP) projector, or a short throw projector. The plurality of positioning devices PR1 to PR4 are disposed on the projection plane 10 for determining a display range of the projected image. The plurality of positioning devices PR1 to PR4 can be a plurality of photoresistors, a plurality of infrared transceivers, a plurality of photodiodes, a plurality of optical sensors, or a plurality of devices capable of performing a coordinate positioning function. Further, the projector system 100 is not limit to using four positioning devices PR1 to PR4. Generally, N positioning devices PR1 to PRN can be introduced to the projector system 100. N is a positive integer greater than three. The N positioning devices PR1 to PRN can be used for forming a closed range on the projection plane 10. However, for simplicity, the projector system 100 with four positioning devices PR1 to PR4 is illustrated later. In the projector system 100, positions of the plurality of positioning devices PR1 to PR4 on the projection plane 10 are within an optical mask range of the first projector 11. A reason is illustrated below. Any projector has limitations of an optical mask angle and an optical mask range, depending on a throw ratio supported by the projector and a wide-angle range supported by a lens of the projector. If the positions of the positioning devices PR1 to PR4 on the projection plane 10 are disposed outside the optical mask range of the first projector 11, the first projector 11 cannot project the light beam to generate a projected image cornered at coordinates of the positioning devices PR1 to PR4. Therefore, the plurality of positioning devices PR1 to PR4 must be reasonably disposed on the projection plane 10 within the optical mask range of the first projector 11. Further, the positioning devices PR1 to PR4 can be temporarily fixed on the projection plane 10 by any method, such as a pasting method, an attaching method, an adhering method, or a magnetic suction method. Allocations of the positioning devices PR1 to PR4 can be arbitrarily adjusted according to the user's preferences. The processor 12 is coupled to the first projector 11 and the plurality of positioning devices PR1 to PR4 for controlling the first projector 11 according to the plurality of coordinates of the plurality of positioning devices PR1 to PR4. The processor 12 can be a central processing unit, a graphics card, a microprocessor, or a logical operation unit. The processor 12 can also be integrated into the first projector 11, such as a processing chip (Scaler) of the first projector 11. Any reasonable hardware modification falls into the scope of the present invention. In the projector system 100, after the processor 12 acquires the plurality of coordinates of the plurality of positioning devices PR1 to PR4 on the projection plane 10, the processor 12 controls the first projector 11 for adjusting a first raw image (hereafter, say “the first raw image RIMG1” in FIG. 2) projected by the first projector 11 to a first adjusted image (hereafter, say “the first adjusted image CIMG1”) cornered at the plurality of coordinates. A method for generating the first adjusted image CIMG1 is illustrated below.

FIG. 2 is an illustration of adjusting the first raw image RIMG1 projected by the first projector 11 to the first adjusted image CIMG1 of the projector system 100. Here, when the first projector 11 projects an image on a screen (projection plane 10), the projected image may be deformed by introducing a non-rectangular optical deformation effect due to offset of a projection angle, especially in a short throw projector with a large projection angle. For example, when the first projector 11 is tilted upward, the first raw image RIMG1 projected on the projection plane 10 may be distorted as a trapezoid shape with a shorter upper side and a longer lower side. However, since the plurality of positioning devices PR1 to PR4 are fixed on the projection plane 10, the processor 12 can control the first projector 11 for adjusting a shape and a position of the first raw image RIMG1 according to the coordinates of the plurality of positioning devices PR1 to PR4. For example, an image quality of the first projector 11 is set to full high definition (FHD) with an aspect ratio equal to 1920×1080 pixels. However, since the offset of the projection angle is introduced, after the first raw image RIMG1 is projected by the first projector 11, the first raw image RIMG1 displayed on the projection plane 10 is distorted as the trapezoid shape. However, positions of the plurality of positioning devices PR1 to PR4 on the projection plane 10 can be pre-allocated within the FHD image range for calibrating the first raw image RIMG1, such as coordinates (0,1080), coordinates (1920,1080), coordinates (0,0), and coordinates (1920,0). In other words, the first raw image RIMG1 projected by the first projector 11 can be a non-rectangular image. The first adjusted image CIMG1 can be a rectangular image. However, the first adjusted image CIMG1 can be any polygonal image defined by the user. A method for adjusting the first raw image RIMG1 to the first adjusted image CIMG1 is illustrated below.

First, after the processor 12 acquires the coordinates of the positioning devices PR1 to PR4, the processing device 12 can detect a shape and each edge length of a region cornered at the coordinates of the positioning devices PR1 to PR4. Then, the processor 12 can perform a pixel interpolation process to the first raw image RIMG1 projected by the first projector 11. For example, the processor 12 can proportionally enlarge or reduce objects of the first raw image RIMG1 along the horizontal axis and the vertical axis according to each edge length of the region cornered at the coordinates of the positioning devices PR1 to PR4. For example, a long side of the trapezoidal first raw image RIMG1 can be reduced to approach a line between positioning devices PR3 and PR4. A short side of the trapezoidal first raw image RIMG1 can be reduced to approach a line between positioning devices PR1 and PR2. One oblique side of the trapezoidal first raw image RIMG1 can be proportionally adjusted to approach a line between positioning devices PR1 and PR3. Another oblique side of the trapezoidal first raw image RIMG1 can be proportionally adjusted to approach a line between positioning devices PR2 and PR4. In other words, the processor 12 can perform the pixel interpolation process to the first raw image RIMG1 projected by the first projector 11 for deforming the first raw image RIMG1 according to the plurality of coordinates of the plurality of positioning devices PR1 to PR4. Then, the processor 12 can control the first projector 11 to project the deformed first raw image cornered at the plurality of coordinates on the projection plane 10 for generating the first adjusted image CIMG1.

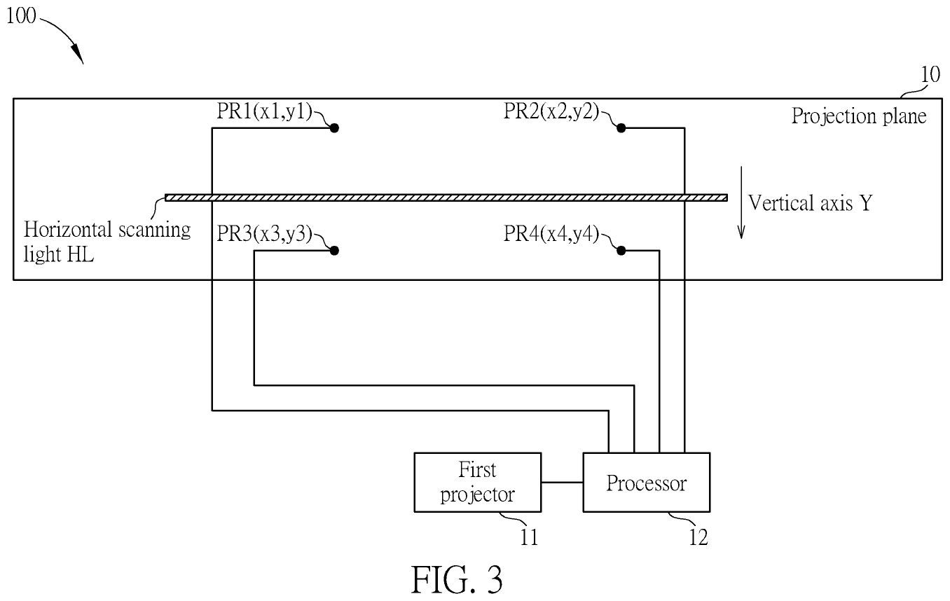

FIG. 3 is an illustration of scanning the projection plane 10 along the vertical axis Y by using horizontal scanning light HL of the projector system 100. As mentioned previously, the processor 12 requires detecting the coordinates of the positioning devices PR1 and PR4 in order to control the first projector 11 for generating the first adjusted image CIMG1. A method for detecting vertical coordinates of the positioning devices PR1 and PR4 by the processor 12 is illustrated below. First, the processor 12 can control the first projector 11 to emit the horizontal scanning light HL for scanning the projection plane 10 along the vertical axis Y. For example, the horizontal scanning light HL can be used for scanning the projection plane 10 from a top side to a bottom side along the vertical axis Y. An intensity of the horizontal scanning light HL is greater than an intensity of ambient light. Since the positioning devices PR1 and PR4 can be photoresistors, when the horizontal scanning light HL is used for scanning the projection plane 10, an intensity of light received by each positioning device may be changed. Therefore, each positioning device of the plurality of positioning devices PR1 to PR4 can generate a current fluctuation after the horizontal scanning light HL is received. The processor 12 can generate coordinate information of the vertical axis Y of the plurality of coordinates according to positions of the horizontal scanning light HL along the vertical axis Y when the current fluctuation is greater than a threshold (i.e., greater than 25% current fluctuation). For simplicity, the coordinates of the plurality of positioning devices PR1 to PR4 belong to coordinates of a Cartesian coordinate system, and can be denoted as PR1(x1,y1) to PR4(x4,y4). For example, the positioning device PR1 can be a photoresistor. When the positioning device PR1 receives the ambient light, the positioning device PR1 can generate a resistance value R1 according to the intensity of the ambient light. In other words, when no horizontal scanning light HL is received by the positioning device PR1, a current I1 passing through the positioning device PR1 can be detected. However, when the horizontal scanning light HL is received by the positioning device PR1, the positioning device PR1 can generate a resistance value R1′ according to the intensity of the ambient light and the intensity of the horizontal scanning light HL. The resistance value R1′ can be smaller than the resistance value R1. Since the resistance value of the positioning device PR1 is changed from R1 to R1′, the current passing through the positioning device PR1 is changed from I1 to I1′. The current I1′ can be greater than the current I1. Therefore, when the processor 12 detects that the current passing through the positioning device PR1 is changed from I1 to I1′ (i.e., a current variation is greater than the threshold), the processor 12 can generate vertical coordinate information of the positioning device PR1 according to the position of the horizontal scanning light HL on the projection plane 10 along the vertical axis Y, such as generating coordinates as PR1(x1,1080) of the FHD image. Similarly, the processor 12 can generate vertical coordinate information of the positioning device PR2, such as PR2(x2,1080) of the FHD image. The processor 12 can generate vertical coordinate information of the positioning device PR3, such as PR3(x3,0) of the FHD image. The processor 12 can generate vertical coordinate information of the positioning device PR4, such as PR4(x4,0) of the FHD image.

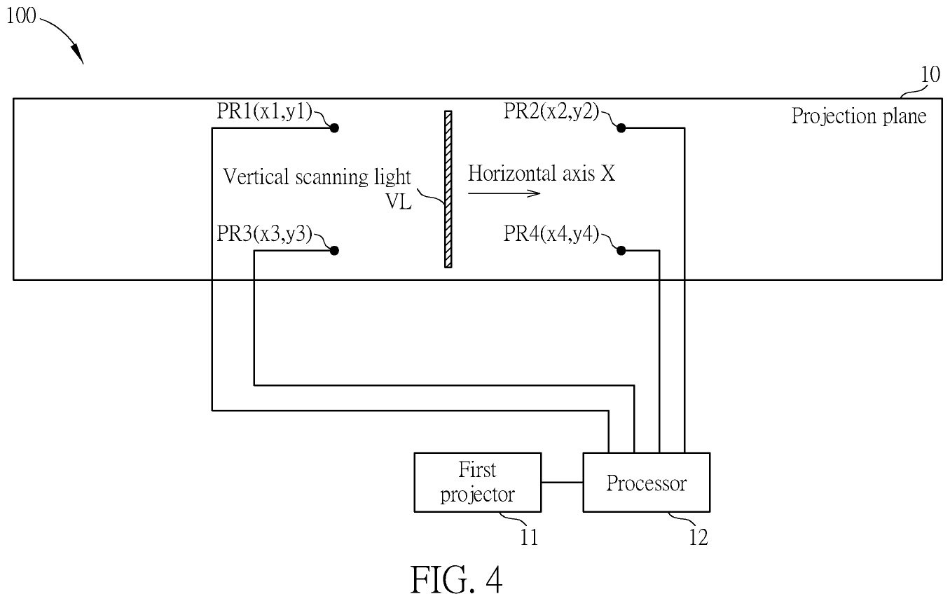

FIG. 4 is an illustration of scanning the projection plane 10 along a horizontal axis X by using vertical scanning light VL of the projector system 100. As previously mentioned, the processor 12 requires detecting the coordinates of the positioning devices PR1 and PR4 in order to control the first projector 11 for generating the first adjusted image CIMG1. A method for detecting horizontal coordinates of the positioning devices PR1 and PR4 by the processor 12 is illustrated below. First, the processor 12 can control the first projector 11 to emit the vertical scanning light VL for scanning the projection plane 10 along the horizontal axis X. For example, the vertical scanning light VL can be used for scanning the projection plane 10 from a left side to a right side along the horizontal axis X. An intensity of the vertical scanning light VL is greater than the intensity of the ambient light. The positioning devices PR1 and PR4 can be photoresistors. When the vertical scanning light VL is used for scanning the projection plane 10, an intensity of light received by each positioning device may be changed. Therefore, each positioning device of the plurality of positioning devices PR1 to PR4 can generate a current fluctuation after the vertical scanning light VL is received. The processor 12 can generate coordinate information of the horizontal axis X of the plurality of coordinates according to positions of the vertical scanning light VL along the horizontal axis X when the current fluctuation is greater than a threshold (i.e., greater than 25% current fluctuation). For simplicity, the coordinates of the plurality of positioning devices PR1 to PR4 belong to coordinates of the Cartesian coordinate system, and can be denoted as PR1(x1,y1) to PR4(x4,y4). For example, the positioning device PR1 can be the photoresistor. When the positioning device PR1 receives the ambient light, the positioning device PR1 can generate the resistance value R1 according to the intensity of the ambient light. In other words, when no vertical scanning light VL is received by the positioning device PR1, the current I1 passing through the positioning device PR1 can be detected. However, when the vertical scanning light VL is received by the positioning device PR1, the positioning device PR1 can generate the resistance value R1′ according to the intensity of the ambient light and the intensity of the vertical scanning light VL. The resistance value R1′ can be smaller than the resistance value R1. Since the resistance value of the positioning device PR1 is changed from R1 to R1′, the current passing through the positioning device PR1 is changed from I1 to I1′. The current I1′ can be greater than the current I1. Therefore, when the processor 12 detects that the current passing through the positioning device PR1 is changed from I1 to I1′ (i.e., a current variation is greater than the threshold), the processor 12 can generate horizontal coordinate information of the positioning device PR1 according to the position of the vertical scanning light VL on the projection plane 10 along the horizontal axis X, such as generating coordinates as PR1(0,y1) of the FHD image. Similarly, the processor 12 can generate horizontal coordinate information of the positioning device PR2, such as PR2(1920,y2) of the FHD image. The processor 12 can generate horizontal coordinate information of the positioning device PR3, such as PR3(0,y3) of the FHD image. The processor 12 can generate horizontal coordinate information of the positioning device PR4, such as PR4(1920,y4) of the FHD image.

By doing so, the projector system 100 can acquire vertical coordinates of the plurality of positioning devices PR1 to PR4 as PR1(x1,1080), PR2(x2,1080), PR3(x3,0), and PR4(x4,0) by using the horizontal scanning light HL. The projector system 100 can acquire horizontal coordinates of the plurality of positioning devices PR1 to PR4 as PR1(0,y1), PR2(1920,y2), PR3(0,y3), and PR4(1920,y4) by using the vertical scanning light VL. Therefore, by combining information of the vertical coordinates and information of the horizontal coordinates, the processor 12 of the projector system 100 can acquire two-dimensional coordinates of the positioning devices PR1 to PR4, such as PR1(0, 1080), PR2(1920,1080), PR3(0,0), and PR4(1920,0).

However, the method of acquiring coordinates of the plurality of positioning devices PR1 to PR4 in the projector system 100 is not limited to FIG. 3 and FIG. 4. For example, the positioning devices PR1 to PR4 can be infrared receivers. The first projector 11 can directly emit invisible light (i.e., an infrared signal) to the positioning devices PR1 to PR4 for requesting the positioning devices PR1 to PR4 to transmit their coordinates through a wireless channel. Any coordinate detection method falls into the scope of the present invention.

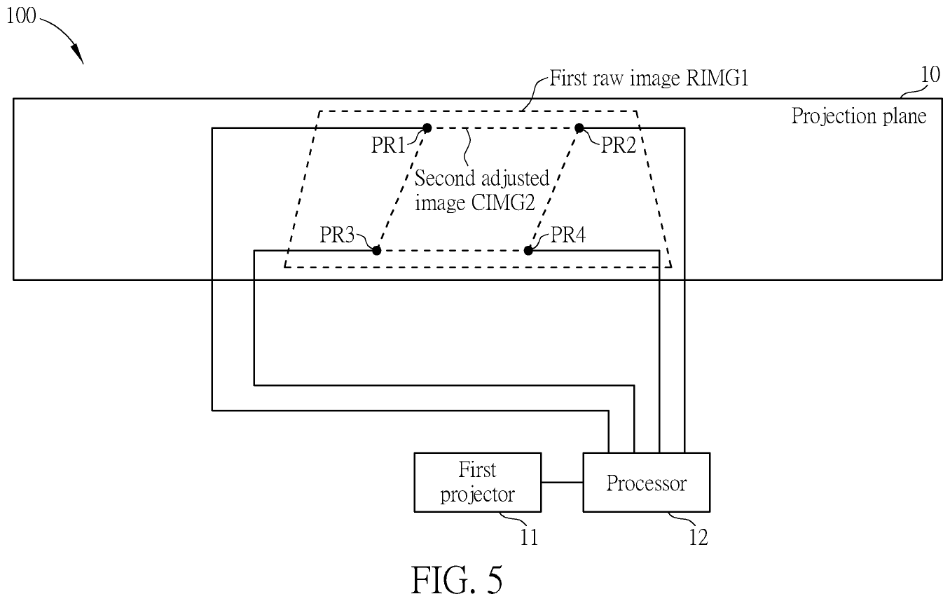

FIG. 5 is an illustration of moving the plurality of positioning devices PR1 to PR4 for generating a second adjusted image CIMG2 of the projector system 100. In the projector system 100, the plurality of positioning devices PR1 to PR4 are temporarily fixed on the projection plane 10 and movable. After the plurality of positioning devices PR1 to PR4 are moved, the processor 12 can update the plurality of coordinates of the positioning devices PR1 to PR4. For example, in FIG. 2, initial positions of the positioning devices PR1 to PR4 can be four vertices of a rectangular image with FHD resolution, such as coordinates PR1(0,1080), coordinates PR2(1920,1080), coordinates PR3(0,0), and coordinates PR4(1920,0) on the image plane 10. As previously mentioned, the positioning devices PR1 to PR4 can be temporarily fixed on the projection plane 10 by any method, such as the pasting method, the attaching method, the adhering method, or the magnetic suction method. Therefore, positions of the positioning devices PR1 to PR4 can be reasonably adjusted at any time according to a requirement of the user for facilitating to perform a customized image calibration process. For example, the initial positions of the positioning devices PR1 to PR4 can be four vertices of the rectangular image with FHD resolution. After the first projector 11 projects the first adjusted image CIMG1 cornered at the plurality of coordinates of the positioning devices PR1 to PR4, the user can adjust positions of the positioning devices PR1 to PR4. In FIG. 5, the user can adjust positions of four positioning devices PR1 to PR4 from four vertices of the rectangular image with FHD resolution to four vertices of a parallelogram region. Then, the processor 12 can control the first projector 11 to project a second adjusted image CIMG2 cornered at a plurality of updated coordinates. In other words, the projector system 100 can dynamically adjust a position and a shape of the second adjusted image CIMG2 projected on the projection plane 10 according to the updated coordinates (or say, current coordinates) of the positioning devices PR1 to PR4. Therefore, the projector system 100 has following advantages. First, the user can appropriately move the positions of the positioning devices PR1 to PR4 for adjusting the shape and the position of the projected image. Thus, the projector system 100 can provide high operational flexibility. Second, since the positioning devices PR1 to PR4 can be temporarily fixed on the projection plane 10 by the pasting method, the attaching method, the adhering method, or the magnetic suction method, they are easily displaced by external force collision. When at least one positioning device is displaced by external force collision, the user can immediately reset a position of the displaced positioning device for quickly calibrating the projected image displayed on the projection plane 10.

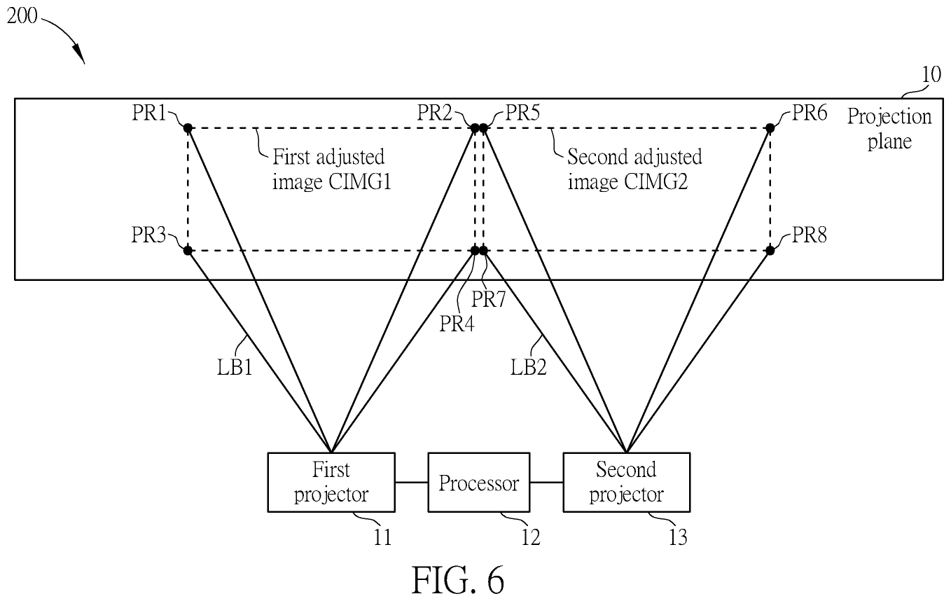

FIG. 6 is an illustration of introducing a second adjusted image CIMG2 projected by a second projector 13 for combining with the first adjusted image CIMG1 to form a stitching image of the projector system 100. The second projector 13 can be introduced to the projector system 100. However, in order to avoid ambiguity, in FIG. 6, the projector system 100 with the second projector 13 is denoted as a projector system 200 hereafter. The projector system 200 can include all components of the projector system 100, a plurality of additional positioning devices PR5 to PR8, and the second projector 13. The plurality of additional positioning devices PR5 to PR8 can be coupled to the processor 12 and disposed on the projection plane 10. The plurality of additional positioning devices PR5 to PR8 can be used for determining a range of another projected image displayed on the projection plane 10. Similarly, the plurality of additional positioning devices PR5 to PR8 can be the plurality of photoresistors, the plurality of infrared transceivers, the plurality of photodiodes, the plurality of optical sensors, or the plurality of devices capable of performing the coordinate positioning function. The second projector 13 is coupled to the processor 12 for projecting another image to the projection plane 10. The second projector 13 can be any type of projectors, such as the laser projector, the digital light processing projector, or the short throw projector. The processor 12 can acquire a plurality of additional coordinates of the plurality of additional positioning devices PR5 to PR8 on the projection plane 10. Further, the processor 12 can control the second projector 13 for adjusting a second raw image projected by the second projector 13 to the second adjusted image CIMG2 cornered at the plurality of additional coordinates. The second adjusted image CIMG2 can be a polygonal image. In FIG. 6, the first projector 11 emits a first light beam LB1 for projecting the first adjusted image CIMG1 on the projection plane 10. The second projector 13 emits a second light beam LB2 for projecting the second adjusted image CIMG2 on the projection plane 10. Particularly, the first adjusted image CIMG1 and the second adjusted image CIMG2 can form a stitching image with the polygonal shape. In other words, positions of the positioning device PR2 and the positioning device PR5 are substantially overlapped. Positions of the positioning device PR4 and the positioning device PR7 are substantially overlapped. According to positions of the positioning device PR1 to the positioning device PR8, the first adjusted image CIMG1 and the second adjusted image CIMG2 can form the stitching image displayed on the projection plane 10.

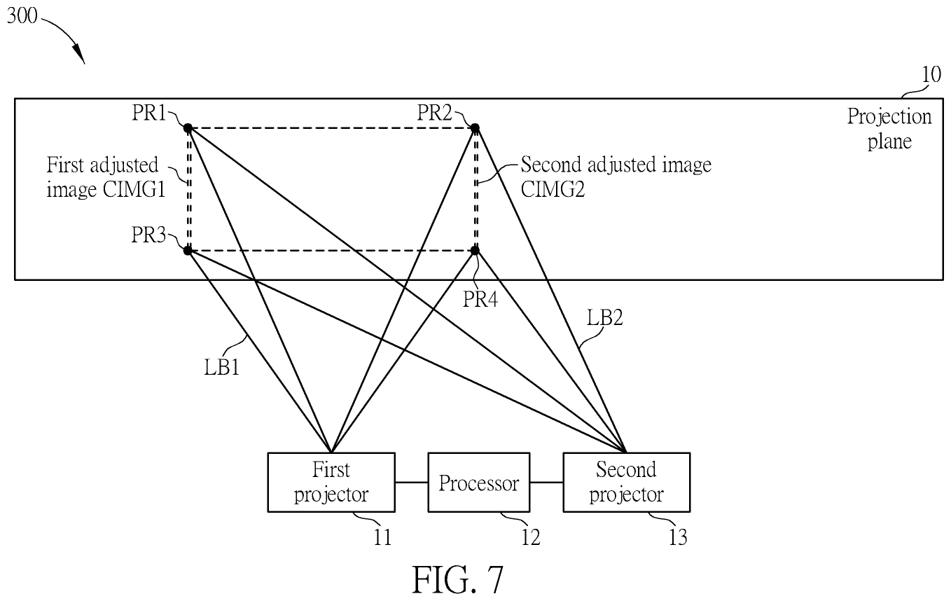

FIG. 7 is an illustration of introducing a second adjusted image CIMG2 projected by the second projector 13 for overlaying with the first adjusted image CIMG1 to form an overlapped image of the projector system 100. The second projector 13 can be introduced to the projector system 100. However, in order to avoid ambiguity, in FIG. 7, the projector system 100 with the second projector 13 is denoted as a projector system 300 hereafter. The projector system 300 can include all components of the projector system 100 and the second projector 13. The second projector 13 can be coupled to the processor 12 for projecting another image to the projection plane 10. The second projector 13 can be any type of projectors, such as the laser projector, the digital light processing projector, or the short throw projector. Further, the processor 12 can control the second projector 13 for projecting the second adjusted image CIMG2 cornered at the plurality of coordinates of the plurality of positioning devices PR1 to PR4. In other words, in the projector system 300, since the first projector 11 and the second projector 13 jointly use information of coordinates of the positioning devices PR1 to PR4, positions and shapes of the first adjusted image CIMG1 projected by the first projector 11 and the second adjusted image CIMG2 projected by the second projector 13 are identical. In other words, the first adjusted image CIMG1 and the second adjusted image CIMG2 can form an overlapped image. Since the first adjusted image CIMG1 and the second adjusted image CIMG2 can be regarded as two image layers of the overlapped image, the overlapped image displayed on the projection plane 10 can provide enhanced image details and color tones.

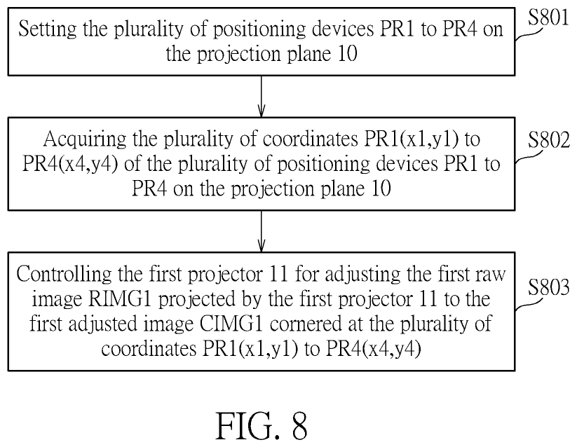

FIG. 8 is a flow chart of an image calibration method performed by the projector system 100. The image calibration method can include step S801 to step S803. Any reasonable technology modification falls into the scope of the present invention. Step S801 to step S803 are illustrated below.
step S801: setting the plurality of positioning devices PR1 to PR4 on the projection plane 10;
step S802: acquiring the plurality of coordinates PR1(x1,y1) to PR4(x4, y4) of the plurality of positioning devices PR1 to PR4 on the projection plane 10;
step S803: controlling the first projector 11 for adjusting the first raw image RIMG1 projected by the first projector 11 to the first adjusted image CIMG1 cornered at the plurality of coordinates PR1(x1,y1) to PR4(x4, y4).

Details of step S801 to step S803 are illustrated previously. Thus, they are omitted here. Further, the projector system 100 is not limited to adjusting the first raw image RIMG1 to the first adjusted image CIMG1 with a rectangular shape. The first raw image RIMG1 can be adjusted to any polygonal image, such as a pentagonal image, a hexagonal image, or a parallelogram image. Further, the processor 12 of the projector system 100 can cooperate with a graphics card of a computer to control the projector for projecting an entire computer desktop screen to a predetermined projection plane. Thus, the projector system 100 can be used for calibrating distortions of the projected image and can provide high operational flexibility.

To sum up, the present invention discloses a projector system for calibrating the projected image. Instead of using a keystone image calibration process for adjusting a distorted image by conventional projectors, the projector system of the present invention can be used for calibrating the distorted image according to predetermined coordinates, thereby providing high operational efficiency and high calibration accuracy. The projector system can use a plurality of positioning devices for determining vertices of an adjusted image projected on the projection plane. After positions of the plurality of positioning devices are detected, the projector can emit a light beam to project the adjusted image displayed on the projection plane. Further, a shape and a position of the adjusted image displayed on the projection plane can be changed at any time according to user's requirement. In conclusion, the projector system of the present invention is capable of calibrating the projected image, and capable of generating a stitching image and an overlapped image by combining a plurality of projected images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image calibration method comprising:
setting a plurality of positioning devices on a projection plane;
acquiring a plurality of coordinates of the plurality of positioning devices on the projection plane; and
controlling a first projector for adjusting a first raw image projected by the first projector to a first adjusted image cornered at the plurality of coordinates;
wherein the first adjusted image is a polygonal image.

2. The method of claim 1, wherein the plurality of positioning devices are a plurality of photoresistors, the projection plane is a screen, the plurality of positioning devices are adhered to the screen, and the plurality of coordinates of the plurality of photoresistors are within an optical mask range of the first projector.

3. The method of claim 1, wherein the first raw image projected by the first projector is a non-rectangular image, and the first adjusted image is a rectangular image.

4. The method of claim 1, wherein acquiring the plurality of coordinates of the plurality of positioning devices on the projection plane comprises:
emitting horizontal scanning light and/or vertical scanning light by the first projector for scanning the projection plane along a horizontal axis and/or a vertical axis; and
generating coordinate information of the horizontal axis and/or the vertical axis of the plurality of coordinates after the horizontal scanning light and/or the vertical scanning light is received by the plurality of positioning devices;
wherein the plurality of coordinates belong to coordinates of a Cartesian coordinate system, and an intensity of the horizontal scanning light and/or vertical scanning light is greater than an intensity of ambient light.

5. The method of claim 4, wherein generating the coordinate information of the horizontal axis and/or the vertical axis of the plurality of coordinates after the horizontal scanning light and/or the vertical scanning light is received by the plurality of positioning devices comprises:
generating a current fluctuation of each positioning device of the plurality of positioning devices after the horizontal scanning light and/or the vertical scanning light is received by the plurality of positioning devices; and
generating coordinate information of the horizontal axis and/or the vertical axis of the plurality of coordinates according to positions of the horizontal scanning light and/or the vertical scanning light along the horizontal axis and/or the vertical axis when the current fluctuation is greater than a threshold.

6. The method of claim 1, wherein controlling the first projector for adjusting the first raw image projected by the first projector to the first adjusted image cornered at the plurality of coordinates comprises:
performing a pixel interpolation process to the first raw image projected by the first projector for deforming the first raw image according to the plurality of coordinates of the plurality of positioning devices; and
projecting the deformed first raw image cornered at the plurality of coordinates on the projection plane to generate the first adjusted image by the first projector.

7. The method of claim 1, further comprising:
setting a plurality of additional positioning devices on the projection plane;
acquiring a plurality of additional coordinates of the plurality of additional positioning devices on the projection plane; and
controlling a second projector for adjusting a second raw image projected by the second projector to a second adjusted image cornered at the plurality of additional coordinates;
wherein a polygonal range is formed by the plurality of coordinates and the plurality of additional coordinates, and the first adjusted image and the second adjusted image form a stitching image.

8. The method of claim 1, further comprising:
controlling a second projector for adjusting a second raw image projected by the second projector to a second adjusted image cornered at the plurality of coordinates;
wherein the first adjusted image and the second adjusted image form an overlapped image.

9. The method of claim 1, further comprising:
moving the plurality of positioning devices for updating the plurality of coordinates; and
projecting a second adjusted image cornered at a plurality of updated coordinates by the first projector.

10. A projector system comprising:
a first projector configured to project an image;
a projection plane configured to display the image projected by the first projector;
a plurality of positioning devices disposed on the projection plane and configured to determine a display range of the image; and
a processor coupled to the first projector and the plurality of positioning devices and configured to control the first projector according to a plurality of coordinates of the plurality of positioning devices;
wherein after the processor acquires the plurality of coordinates of the plurality of positioning devices on the projection plane, the processor controls the first projector for adjusting a first raw image projected by the first projector to a first adjusted image cornered at the plurality of coordinates, and the first adjusted image is a polygonal image.

11. The system of claim 10, wherein the plurality of positioning devices are a plurality of photoresistors, the projection plane is a screen, the plurality of positioning devices are adhered to the screen, and the plurality of coordinates of the plurality of photoresistors are within an optical mask range of the first projector.

12. The system of claim 10, wherein the first raw image projected by the first projector is a non-rectangular image, and the first adjusted image is a rectangular image.

13. The system of claim 10, wherein the first projector emits horizontal scanning light and/or vertical scanning light for scanning the projection plane along a horizontal axis and/or a vertical axis, the processor generates coordinate information of the horizontal axis and/or the vertical axis of the plurality of coordinates after the horizontal scanning light and/or the vertical scanning light is received by the plurality of positioning devices, the plurality of coordinates belong to coordinates of a Cartesian coordinate system, and an intensity of the horizontal scanning light and/or vertical scanning light is greater than an intensity of ambient light.

14. The system of claim 13, wherein each positioning device of the plurality of positioning devices generates a current fluctuation after the horizontal scanning light and/or the vertical scanning light is received by the plurality of positioning devices, and the processor generates coordinate information of the horizontal axis and/or the vertical axis of the plurality of coordinates according to positions of the horizontal scanning light and/or the vertical scanning light along the horizontal axis and/or the vertical axis when the current fluctuation is greater than a threshold.

15. The system of claim 10, wherein the processor performs a pixel interpolation process to the first raw image projected by the first projector for deforming the first raw image according to the plurality of coordinates of the plurality of positioning devices, and the processor controls the first projector to project the deformed first raw image cornered at the plurality of coordinates on the projection plane for generating the first adjusted image.

16. The system of claim 10, further comprising:
a plurality of additional positioning devices disposed on the projection plane; and
a second projector coupled to the processor;
wherein the processor acquires a plurality of additional coordinates of the plurality of additional positioning devices on the projection plane, controls the second projector for adjusting a second raw image projected by the second projector to a second adjusted image cornered at the plurality of additional coordinates, a polygonal range is formed by the plurality of coordinates and the plurality of additional coordinates, and the first adjusted image and the second adjusted image form a stitching image.

17. The system of claim 10, further comprising:
a second projector coupled to the processor;
wherein the processor controls the second projector for adjusting a second raw image projected by the second projector to a second adjusted image cornered at the plurality of coordinates according to the plurality of coordinates of the plurality of positioning devices, and the first adjusted image and the second adjusted image form an overlapped image.

18. The system of claim 10, wherein the processor updates the plurality of coordinates when the plurality of positioning devices are moved, and the processor controls the first projector to project a second adjusted image cornered at a plurality of updated coordinates.
